(19) United States
(12) Patent Application Publication
(10) Pub. No.: US 2020/0239818 A1
(43) Pub. Date: Jul. 30, 2020

(54) INFUSED WINE AND PROCESS FOR MAKING SAME

(71) Applicant: La Cuisine Chef's Wine, Ltd., Chicago, IL (US)

(72) Inventors: Arman Falsafi, Chicago, IL (US); Shawn McNamara, Kalamazoo, MI (US)

(21) Appl. No.: 16/773,377

(22) Filed: Jan. 27, 2020

Related U.S. Application Data
(60) Provisional application No. 62/797,791, filed on Jan. 28, 2019.

(51) Int. Cl. C12G 1/00

(52) U.S. Cl. CPC C12G 1/00; C12G 2200/21

(57) ABSTRACT

A method and system for preserving wine from spoilage after exposure to oxygen is disclosed. The method includes adding natural herbs and spices to wine in a manner that enhances the stability of the wine product after exposure to oxygen. The example method adds herbs and spices to wine in a sealed container for a period of time sufficient to allow characteristics of the herbs and spices to be infused into the wine. The infused wine has an extended shelf life, once exposed to oxygen, thereby making it amenable to commercial manufacturing and distribution after the usual one-week shelf-life period for opened and untreated wine.

### PRIORITY CLAIM

The present disclosure claims priority to U.S. Provisional Ser. No. 62/797,791 filed Jan. 28, 2019. The contents of that application in their entirety are hereby incorporated by reference.

### TECHNICAL FIELD

The present disclosure relates generally to wine, and more specifically to a method to preserve wine from spoilage using natural herbs and spices with anti-oxidant and anti-bacterial properties.

### BACKGROUND

Alcoholic beverages have been a part of human existence potentially as far back as prehistoric times, with virtually every human civilization and culture producing them in some form. Any liquid solution containing sugar when exposed to air is likely to undergo some degree of fermentation, the process by which the sugar is consumed by the wild yeasts generally present in the environment to produce alcohol, carbon dioxide and heat.

The simplicity of this natural process is the main reason for the prevalence as well as the large variety of alcoholic beverages available today. Alcoholic beverages can be produced from a variety of sugar sources including fruits, grains and rice. Wine, by definition, is the alcoholic beverage produced from any fruit. No fruit-based alcoholic beverage is as extensively produced or consumed, nor is as highly regarded as wine produced from grapes. Grape wine (“wine” hereafter) is produced from the exposure of grape juice to yeast and oxygen.

Wine production dates back thousands of years and a wide variety of wine has been and continues to be produced throughout the world. Most broadly speaking, wine may be categorized by its color (“red” wine is produced from red grapes and fermented with skin contact while “white” wine is produced from either red or white grapes and fermented without skin contact), by the presence or absence of carbon dioxide bubbles (“still” vs. “sparkling”) or by its level of sweetness. Thus, “dry” wines have no discernible trace of residual sugar as a result of the yeasts having fully consumed all the sugar, while “sweet” wines have a material amount of residual sugar, either because the yeast did not fully complete the fermentation process or because sugar has been added to the wine post fermentation. For any given batch of wine, the total amount of sugar in the grape juice dictates the maximum amount of alcohol (usually between 8 and 18%) that the fermentation process can potentially yield in the final product. It is common for ordinary “table” wine to have an alcohol level of around 12 to 14%.

Thousands of different varietals of grapes are cultivated and fermented into a vast array of wines and wine styles throughout the world, using a great number of both ancient and modern winemaking techniques and technology. The chemical transformation of grape juice to wine, which comes about simply by the consumption of sugar and the production of alcohol by yeast cells, can impart upon the resulting beverage a range of aromas and flavors entirely unique to wine and specific to the grape varietal used to produce it. Furthermore, additional complex aromas and flavors are imparted to wine through a vast array of possible winemaking techniques, one of the most common of which is wood aging. The winemaking process in essence produces a unique product each time, one with an individualized combination of aromas and flavors as well as desirable structural components (attributes sensed strictly in the human mouth), which include residual sugar, alcohol, tannin as well as various types of “good” acidity including malic, lactic, citric, and tartaric acid.

Wine is also unique in its ability and tendency to evolve over time. It is the combination these characteristics that makes wine so interesting to many who consume it. The winemaking process transforms the grape from a volatile, highly perishable fruit that lasts only a few days after harvest into a beverage with a significantly longer potential shelf life. For most of its multi-millennial history wine has been prized above all for its ability to provide both sustenance and clean hydration. However, with the more recent advent of refrigeration and water filtration, wine now serves primarily as a pleasurable drink that may be consumed for a variety of purposes, including for intoxication, celebration and especially as an accompaniment to food in enhancing the dining experience. In addition, due the complex combination of aromas and flavors as well as structural components such as acidity and body which it can impart, wine serves as an essential ingredient in a broad range of simple and elaborate cooking techniques, including for marinating, braising, sautéing, stir-frying and poaching, as well as for sauces, gravies and reductions, much the same way that herbs and spices are used.

During winemaking and subsequently due to the high acid content/low pH of both the grape juice as well as the finished wine, wine and winemaking are not susceptible to the growth of human pathogens which would cause human illness. However, a number of non-toxic microorganisms that include specific strains of yeasts and bacteria have the potential to flourish at various points in the life cycle of wine, beginning as early as when the grapes are still ripening on the vine all the way until the resulting wine has been consumed. Many of these microorganisms have the potential to bring about chemical changes that adversely affect the desirable characteristics of the end product including its aromas, flavors and structurally components, essentially spoiling the wine. The suitable ecology that enable any particular one of these microorganisms to affect and spoil the wine varies and is impacted by a variety of factors, including time, temperature, pH/acidity, the presence or absence of sugar, alcohol levels and especially oxygen. Cooling, although often expensive, is an effective strategy in preventing the growth of spoilage microorganisms, both in juice and wine. However, cooling only slows the growth and activity of microorganisms but does not inactivate or eliminate them from the process. A subsequent rise in temperatures will restart the contamination process.

Paradoxically, although oxygen in limited doses is a key element in the winemaking process as well as a critical factor in the desirable aging of red wine in particular, it is also a most significant contributor to the development of many spoilage microorganisms including oxidative yeasts and acetic bacteria, and is particularly detrimental to the quality of white wine. Acetobacter, a particular genus of acetic bacteria noteworthy in its resistance to alcohol, is one of the main causes of spoilage of wine. In the presence of oxygen ,acetobacter metabolizes alcohol and sugar into acetic acid, a particular type of “volatile acid” generally deemed undesirable in wine, giving wine a sharp “vinegar” taste after a short period of time and eventually turning the wine into actual vinegar.

The risk of spoilage of wine as a result of exposure to excessive oxygen begins early and continues throughout the wine production process. Consequently minimizing/eliminating oxygen exposure throughout the wine production process is one of the major challenges and responsibilities of a winemaker. However, once an otherwise healthy bottle of wine is opened for consumption, exposure to oxygen is inevitable and the wine is once again susceptible to spoilage by aerobic bacteria. If not consumed in a timely manner the wine will become vinegar in a relatively short time.

The microbiological stability of wine is fundamental to preserve its quality. It may be achieved by the use of chemical preservatives and/or physical treatments, aimed at killing microorganisms or at least at inhibiting their proliferation, or at physically removing them from wine. A number of proven and experimental techniques are relied upon by winemakers to inhibit microorganism growth by reducing the presence of oxygen prior to packaging. The most common includes the judicious addition of sulfites in liquid form. Inert gases such as Argon (Ar), Carbon Dioxide (CO2) and Nitrogen (N) are also commonly injected into fermentation and storage containers as well as into the end packaging as a means of displacing oxygen.

Sulfites, the anti-oxidative and antiseptic/anti-microbial qualities of which are believed to have been discovered during Roman times, are present in all wine in small quantities as a natural byproduct of the fermentation process. Further moderate artificial addition of sulfites to wine is the most extensively used and effective means of combating wine spoilage from oxidation. A liquid mixture of potassium metabisulfite powder and water is commonly added to wine throughout the production process (from crushing through fermentation, aging and bottling) yielding a certain proportion of “free” Sulfur Dioxide (SO2) which serves to bind with and neutralize oxygen molecules that would otherwise enable the growth of spoiling bacteria, with the rest combining with other elements in the wine (“bound” SO2). Because free SO2 levels naturally decrease over time through continual binding, measuring, monitoring and augmenting the quantity of free SO2 throughout the production process of any batch of wine is one of the critical tasks of the winemaker. In addition, because high levels of SO2 affect the aroma and flavor of wine giving it a detectable “burnt match” smell, winemakers must carefully balance the preservative benefits of sulfites against the adverse impact on wine quality.

Due to potential health concerns and side effects, the amount of SO2 which may be added to wine is strictly regulated around the world. In the US, any wine end product with more than 10 parts per million (PPM) must bear a “contains sulfites” label, with the maximum permissible limit set at 350 PPM. At bottling, ordinary table wine commonly contains 20-50 parts per million (PPM) of free SO2.

It should be noted that Heat Pasteurization, a process effected by heating a liquid to a certain elevated temperature and holding it at that temperature for a required time as a common means of eliminating bacteria and other microbes, cannot be employed for wine as the elevated temperature destroys and damages the delicate aromas and flavors of wine and imparts a burnt or cooked taste.

Volatile acidity is present in varying degrees in all wines, with a new, healthy table wine generally containing less than 0.4 g/L. Historically, the predominant means of detecting wine spoilage from volatile acidity has been through sensory evaluation, namely the senses of smell and taste. Volatile acidity is susceptible to sensory detection at concentrations ranging from 0.6 to 0.8 g/L. Variability in individual preferences notwithstanding, volatile acidity concentrations above 0.8 g/L are generally deemed to be a fault in all wine, resulting in the deterioration of pleasant aromas and flavors and yielding a noticeable harsh, sour and even bitter after taste akin to vinegar.

More recently, a variety of laboratory techniques and equipment of varying complexity has been developed to more precisely measure volatile acidity in wine. Amongst these, steam distillation using a “Cash” still is the oldest and most commonly used. Alternative procedures include gas chromatography, HPLC and enzymatic test methods.

Most of the wine produced throughout the world is packaged and distributed in 750 mL glass bottles, although increasingly alternative sizes as well as packaging material have been used. The long-standing popularity of the 750 mL glass bottle for wine is attributed to its suitability for consumption in one sitting by two adults, reducing the risk of any surplus that would result in oxidation and spoilage after opening.

When wine is transferred from storage or aging containers to the bottle in the final stages of wine production, a small air gap is left between the wine content and the wine closure, which is generally made of either natural or synthetic cork or metal screw cap. This air gap is intended to absorb the increase and decrease in pressure that may come about from expansion and contraction of wine at variable temperatures. It is common practice for commercial wine producers to inject a small quantity of inert gas such as Argon (Ar) into the bottle to replace/eliminate the residual oxygen in air gap with the goal of preventing spoilage in the sealed wine prior to opening.

After a wine has been bottled and sealed, it can “keep” for years and perhaps decades prior to opening, when stored under proper conditions. The “ageability” of bottled wine under proper conditions is attributable to a number of its structural components, including acidity, alcohol, tannin and sugar. In general, both very low and very high levels of alcohol, high levels of tannins (primary in red wine which is exposed during fermentation to grape skin, seeds and stems containing anti-oxidative and antibacterial polyphenols, making it substantially more stable than white wine) as well as high levels of “good acidity” and residual sugar can act as natural preservatives in bottled wine. In this regard, the production of fortified sweet wines, whereby a neutral distilled spirit is added to wine prior to full fermentation of the grape sugar, was historically intended to further increase the shelf life of still wine by increasing both its alcohol and sugar content.

Once a bottle of wine is opened for consumption, both the poured wine and any wine that remains in the bottle are thereafter exposed to material amounts of oxygen. If a wine is consumed immediately, the exposure to oxygen will not cause spoilage and may indeed “open” the wine and improve its quality in the very short run. However, any open wine that is not consumed within a matter of hours begins to deteriorate almost immediately due to the growth of aerobic bacteria enabled by oxygen, which convert the alcohol to volatile acidity. The shelf life of an open bottle of white table wine containing moderate levels of free SO2 is approximately one to five days, and slightly longer if sealed and refrigerated. Red table wine, due to its higher tannin/polyphenol levels which act as natural antioxidants, may last one and up to two weeks. The open wine's quality noticeably deteriorates steadily over time to the point where it will ultimately more resemble vinegar than wine.

No practical additive except moderate levels of free SO2 has yet been identified to extend the shelf life of an open bottle of wine without impacting the complex set of aromas, flavors and structural components particular to that wine. However, a number of specialty mechanical devices now exist in the marketplace designed to prolong the shelf life of an opened bottle of wine, by reducing its exposure to oxygen and thereby decelerating spoilage, which would enable consumption over a longer duration of time than would otherwise be possible. Such devices include a wine pump which acts to remove oxygen from the open bottle for a limited period of time, the Coravin which acts to simultaneously pump out wine from a sealed bottle while pumping in Argon to fill the air gap created, and the Air Cork Wine Preserver which inserts an air balloon into the open wine bottle to replace the air gap.

The traditional 750 mL glass bottle when opened for non-commercial cooking instead of for consumption as beverage, has a higher likelihood of wine spoilage resulting from exposure to oxygen. This is predominantly due to the judicious use of wine in most cooking recipes, which is likely to leave a substantial amount of an open bottle unused for some time thereafter.

A number of wine products exist in the marketplace today intended to serve as a cooking ingredient and with a significantly longer shelf life after opening as compared with traditional table wine. However, these products contain significant quantities of salt (NaCl)—typically 1.5% or approximately 12.5 pounds of salt per 100 gallons of wine—and other artificial ingredients serving as preservatives. Furthermore, they are often oxidized prior to bottling and ultimately lack the pleasant characteristics generally attributed to wine, making them an inferior alternative to healthy table wine in most recipes.

A limited number of herb-infused alcoholic beverages are available in the marketplace today, including Chartreuse (a distilled alcohol aged with a blend of herbs, plants and flowers), Vermouth (a fortified wine flavored with various botanicals), Benedictine (an herbal liqueur flavored with flowers, berries, herbs, roots and spices) and Izarra (a sweet liqueur flavored with herbs and spices). Although these products enjoy a long shelf life due to their respective high levels of alcohol and possibly sugar relative to wine, they are unsuitable as a common ingredient in mainstream cooking and are not deemed a substitute for wine in most recipes and cooking techniques.

Therefore, there is a considerable culinary and health need to produce unsalted wine infused with select natural herbs that is stable with an extended shelf life both before and after opening and with no appreciable loss of natural wine characteristics which can serve as an alternative both to salted cooking wines as well as wines containing sulfites prevalent in the marketplace today.

There is a need for a process for producing herbal-flavored infused wine from select natural herbs and spices. There is another need for a process for producing a specialty wine having a rich, robust herbal flavor conducive to use in elaborate food cooking techniques as well as human consumption as an aperitif and/or digestif. There is another need for a process for producing herbal flavored wine having a long shelf life, particularly after opening and exposure to oxygen. There is also a need for an herbal flavored wine that does not require refrigeration during storage, particularly after opening and exposure to oxygen.

### SUMMARY

One disclosed example is a method of producing infused wine that includes contacting a quantity of wine with a quantity of herbs and/or spices to form a wine mixture. The wine mixture is placed in a container. The container of the wine mixture is stored at a reduced temperature for a predetermined time. The herbs and/or spices are separated from the wine mixture to produce infused wine. The infused wine is packaged.

Another disclosed example is a system for preserving wine. The system includes a container sealing a mixture of wine, herbs and/or spices. The system includes an isolation area holding the container with the mixture of wine, herbs and/or spices for a predetermined amount of time. The system includes a separator to separate the herbs and/or spices from the wine after the predetermined amount of time. The system includes an end use container to hold the infused wine.

Another disclosed example is a beverage that is a wine infused with a plurality of herbs and spices over a predetermined period of time. Each of the herbs and spices has anti-bacterial, anti-microbial or anti-oxidative characteristics. The period of time is sufficient to allow preservation of the wine against spoilage for at least 90 days after being exposed to oxygen.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a block diagram of a system to produce infused wine with an extended lifetime after opening in accordance with the example technique;

FIG. 2 a flow chart of the inventive process utilizing a tank, vat or similar for the infusion process prior to the end use packaging process; and

FIG. 3 is a flow chart of the inventive process utilizing the end use packaging for the infusion process.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The following process description is provided to enable any person skilled in the art to make and use the invention and sets forth the best modes contemplated by the inventors of carrying out their inventions. Various modifications, however, will remain readily apparent to those skilled in the art, since the general principles of the present invention have been defined herein specifically to provide an example method for producing stable wine infused with select natural herbs and spices.

The present disclosure relates to alcoholic beverages and more particularly for a process to add natural herbs and spices, and essences from herbs and spices, to wine in a manner that enhances the stability of the wine product after exposure to oxygen. The example method produces herbal flavored wine from natural herbs and spices with a rich, robust flavor. The flavored wine has an extended shelf life, once exposed to oxygen, thereby making it amenable to commercial manufacturing and distribution; and consumer household storage well after the usual one-week shelf-life period for opened and untreated wine.

Therefore, the example disclosure addresses the considerable need and benefit in preparing wine infused with select herbs and spices that is stable with an extended shelf life before and after opened (exposed to oxygen) and with no appreciable loss of natural wine characteristics as compared with standard wine, can enhance the flavors of prepared dishes and can also be consumed as an aperitif and/or digestif.

Once the end use packaging is opened by the retail or wholesale consumer, the example infused wine product can be stored with or without refrigeration by the consumer past the usual one (1) week period for opened wine without the use of external preservation techniques such as an oxygen wine pump or other mechanism. The preservation of the infused wine against spoilage produced by the example process lasts over 90 days and may last over 6 months after the exposure to oxygen.

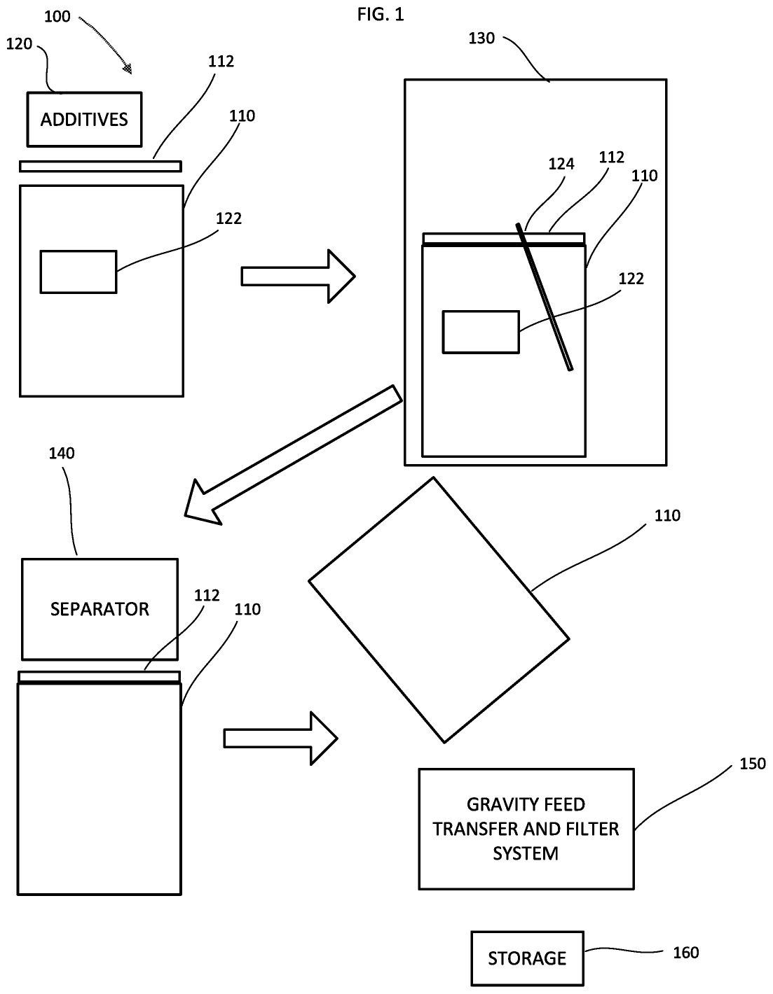

FIG. 1 is an example system 100 for producing infused wines that allow extended storage after opening according to the principles disclosed herein. The system 100 includes a container 110 with a sealed cover 112. In this example, the container 110 may be a large vat, tank or other suitable intermediate container. Any container suitable for wine storage which enables minimal exposure to oxygen, including stainless steel tanks, stainless steel or plastic vats or totes, concrete eggs, clay amphora, tight-grain wooden barrels, bag-in-a-box, or bottles of any size may be used with this process for purposes of the infusion process.

A source of herbs and spices 120 supplies herbs and spices into the wine in the container 110. In this example, the herbs and spices 120 are placed in a carry vessel 122 such as a mesh bag that is submerged in the container 110. The container 110 is placed in a storage location 130 for a predetermined time to macerate or age the mixture. The storage location 130 is preferably held under a relatively cool temperature (45-65 degrees F. but preferably at 50 degrees F.) and is dark. As will be explained the container 110 is stored for a predetermined time for sufficient aging/maceration in the storage location 130.

A stirring mechanism 124 is inserted in the container 110 during the aging/maceration process. The stirring mechanism 124 is activated to stir settled herbs and spices 120 to effect extraction of the herb and spice flavors, aromas, textures, and constituent antioxidant and antibacterial properties to the wine in the container 110. One example of a stirring mechanism may be a lees stirrer such as a curved, stainless steel, sickle-like instrument but other mechanisms such as a bâtonnage cane or a stirring rod may be used.

After the aging/maceration process is complete, a sterile separator 140 is employed to remove the aged herbs and spices from the container 110. In the case where a carrying vessel such as the carry vessel 122 is used for holding the herbs and spices, the vessel 122 is simply removed from the container 110. In the case of directed infusion, a separator 140 such as a mesh cloth is used. After the aged herbs and spices are removed, the infused wine mixture is strained or filtered using a low-oxygen exposure gravity feed transfer and filter system 150. The system 150 filters the wine from the container 110 by gravity through a filter, the filtered wine is then added to storage containers 160. The completed infused wine may be placed in smaller storage container 160 for distribution and packaging.

The example process first mixes wine with finely divided variations of natural herbs and spices 120 in the oxygen-free container 110. The container 110 is sealed and steeped. The container 110 is then placed in the cool, dark storage location 130 to age/macerate the mixture for a time sufficient to extract and transfer the respective herbal flavor, aroma, and the constituent antioxidant and anti-bacterial properties of the herbs and spices into the wine sufficient to reduce microbiological and enzymatic activity. This infusion allows preservation within the end use packaging and during the transport, warehousing, and consumption of the infused wine.

End use packaging described herein includes storage for use by a consumer. A consumer may be a retail consumer, a wholesaler, or a value-added manufacturer wishing to use the infused wine produced by the above described process for further manipulation or further airtight repackaging. End use packaging transfers the produced infused wine to a container such as the end use container 160 in FIG. 1. An end user container may be any suitable container such as a vat, tank, glass or plastic bottle, plastic bladder, can, airtight bag, or Tetra Pak.

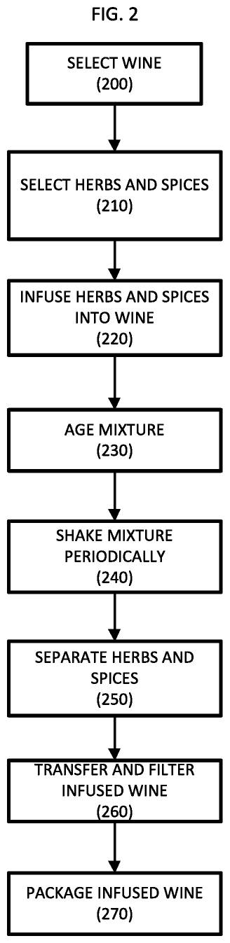

FIG. 2 is a flow chart of the example method of making infused wine using a large vat, tank or other suitable intermediate container such as the container 110. First, an unfortified dry to off-dry drinking wine that has been stored in specific-sized sterilized, sealed, light-free containers at a temperature between 33°-50° F. is selected (200). Natural herbs and spices with uniquely distinctive flavors, aromas, textures, and constituent antioxidant, anti-bacterial and/or anti-microbial properties are then selected (210). The herbs and spices are selected for preservation qualities as well as the desired flavors and aromas that may be imparted to the wine.

The specified quantity of drinking wine with specified quantities are infused with the specific varieties of finely divided select natural herbs and spices (220). The infusion may be performed directly by adding the natural herbs and spices to the wine in the container 100 to form an herbal and spice wine mixture. Alternatively, the infusion may be performed indirectly by submerging a carrying vessel such as the carrying vessel 122 in FIG. 1 containing the herbs and spices in the container 110, in order to form an herbal and spice wine mixture. In this example, rosemary, thyme, sage, and bay leaves herbs and saffron spice is added to the wine to produce the infused wine.

The process then ages/macerates the natural herbal and spice wine mixture for a specified time in a specific-sized sterilized, sealed, light-free and oxygen-free container such as the container 110 at a temperature of about 50-55° F. for approximately two (2) weeks in this example. The aging period is selected to be sufficient to reduce microbiological and enzymatic activity in the herbal and spice wine mixture.

An intermittent bâtonnage process is conducted (240) using a stirring mechanism 124 in FIG. 1 such as the lees stirrer or bâtonnage cane. The intermittent bâtonnage stirs settled herbs and spices during the herbal and spice infusion period to effect extraction of the herb and spice flavors, aromas, textures, and constituent antioxidant and antibacterial properties.

After the aging/maceration process, the aged herbs and spices solid material is separated from the herbal wine infusion mixture using sterilized tools (250). Transferring, straining or filtering the infused wine mixture using the low-oxygen-exposure gravity feed transfer and filter system 150, to maintain the wine and respective herbal and spice flavors, aromas, textures and constituent antioxidant and antibacterial properties of the herbs and spices. In this example, the completed infused herbal and spice wine is stored into a specific-sized sterilized, sealed, light-free, and oxygen-free, end use container 160 at a temperature of about 50-55° F. prior to the end use packaging process and distribution to the market. The infused wine may be stored for as long as desired as long as the storage container is cool and oxygen free.

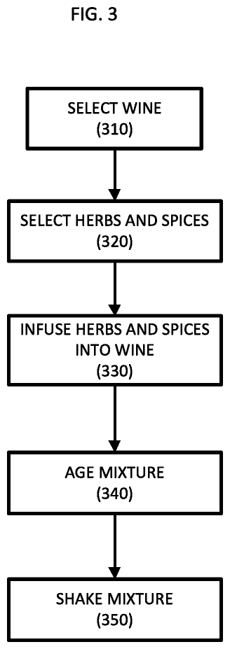

FIG. 3 is a flow chart of the example process utilizing end use packaging for the infusion process. The end use packaging “infusion” process begins by selecting unfortified dry to off-dry drinking wine that has been stored in specific-sized sterilized, sealed, light-free containers at a temperature between 33°-50° F. (310). Natural herbs and spices with uniquely distinctive flavors, aromas, textures, and constituent antioxidant, anti-bacterial and/or anti-microbial properties are selected (320). A specified quantity, adjusted for the end use packaging size, of the specific varieties of finely divided select natural herbs and spices are added into the end use packaging (330).

The natural herbal and spice wine mixture is aged/macerated within the specific-sized sterilized, sealed, end use packaging in a light-free environment at a temperature of about 50° F. for approximately two (2) weeks sufficient to reduce microbiological and enzymatic activity (340). The sealed end use packaging is intermittently shaken to effect extraction of the herb and spice flavors, aromas, textures and constituent antioxidant and antibacterial properties before the infused wine is ready for the market (350). Further shaking, riddling, or remuage actions may take place during the transport of the infused wine product to the consumer.

There are possible permutations of the process and ingredients of the above described process. Other alternative preservatives or preservation methods currently used in the production of cooking wine including potassium sorbate, sodium benzoate, pasteurization, salt, or other preservatives can be used in conjunction with the described processes, but these ingredients are optional.

Any still, dry to off-dry (with less than 3% residual sugar), unfortified wine of any color (white, red, rose) made of any grape varietal or blend of varietals with any level of alcohol up to approximately 18% may be used as the base ingredient for the example infusion process.

Any herb with anti-bacterial, anti-microbial and/or anti-oxidative characteristics, either fresh or dried or any combination thereof such as oregano, rosemary, thyme, sage, bay leaf, parsley, basil, mint, dill, lemongrass, or coriander may be used for the example infusion process. Any spice with anti-bacterial, anti-microbial and/or anti-oxidative characteristics, either in whole or ground form (e.g., saffron, pepper) or any combination thereof of saffron, sumac, pepper, clove, cinnamon, turmeric, cumin, vanilla, mustard, garlic powder, onion powder, ginger may be used for the example infusion process.

Various combinations of fresh or dry herbs and spices rendering uniquely flavored individual wine-infused wine products suitable for different kinds of recipes may be used for the example infusion process. For example, a white wine may be infused with lemongrass, basil and ginger for preparation of Thai dishes; with coriander, dill, parsley, saffron and turmeric for Middle Eastern dishes; or with vanilla for desserts. The example infusion process may be augmented with various combinations of natural and artificial flavoring agents, including other botanicals, extracts, artificial essences, wood or smoked wood chips rendering uniquely flavored individual wine-infused wine products suitable for different recipes. The flavoring agents may be added during the infusion step of the process or prior to packaging.

Different results demonstrate that the infused wine produced by the method described herein shows reduced oxidation with time and hence, an improved aging stability when exposed to oxygen over a period of time. For example, the infused wine produced by the above described process maintains preservation of the wine against spoilage for over 90 days after exposure to oxygen. Empirical observation from at least the following examples reveals that infusions result in significantly enhanced microbiological stability in the infused wine.

In one set of observations, 750 mL of fresh Sauvignon Blanc white drinking wine was commingled with 4.252 grams of fresh rosemary, 1.134 grams of fresh thyme, and 2.835 grams of fresh sage and 0.227 grams of dry bay leaves, for a total of 8.448 grams of fresh and dry herbs. The fresh and dry herbs were commingled with the wine for a period of 3 weeks, to create the example wine infusion. The infused bottle of wine was then occasionally opened to expose the wine infusion to oxygen in the same manner as a consumer would for drinking or cooking over time, and the respective bottle was kept unrefrigerated for 90 days during the observation. The observation consisted of a recently infused wine and non-infused drinking wine (both Sauvignon Blanc), which were each opened and unrefrigerated simultaneously in the same manner.

After 12 weeks, a Certified Sommelier compared the opened infused wine (Wine A) with the opened un-infused Sauvignon Blanc (Wine B) as well as with a freshly opened bottle of non-infused Sauvignon Blanc (Wine C). No significant difference in the underlying volatile acidity was detected between the infused wine (Wine A) and the freshly opened bottle of non-infused wine (Wine C), while a significant amount of volatile acidity was detected in the opened and unrefrigerated non-infused wine (Wine B) relative to both the infused wine (Wine A) and the freshly opened non-infused bottle (Wine C).

In a second set of observations, 750 mL of fresh Chardonnay white drinking wine was commingled with 4.252 grams of fresh rosemary, 1.134 grams of fresh thyme, and 2.835 grams of fresh sage, 0.227 grams of dry bay leaves, and 0.5 gram of ground saffron, for a total of 8.948 grams of fresh and dry herbs and spices, for a period of 3 weeks, to create an example wine infusion. The infused bottle of wine was then occasionally opened to expose the wine infusion to oxygen in the same manner as a consumer would for drinking or cooking over time, and the respective bottle was kept unrefrigerated for 90 days during the observation. The observation consisted of a recently infused wine and non-infused drinking wine (both Chardonnay), which were each opened and unrefrigerated in the same manner.

After 12 weeks, a Certified Sommelier compared the opened infused wine (Wine D) with the opened un-infused Chardonnay (Wine E) as well as with a freshly opened bottle of non-infused Chardonnay (Wine F). No significant difference in the underlying volatile acidity was detected between the infused wine (Wine D) and the freshly opened bottle of non-infused wine (Wine F), while a significant amount of volatile acidity was detected in the opened and unrefrigerated non-infused wine (Wine E) relative to both the infused wine (Wine D) and the freshly opened non-infused bottle (Wine F).

In a third set of observations, 750 mL of fresh Sauvignon Blanc white drinking wine was commingled with 4.252 grams of fresh rosemary, 1.134 grams of fresh thyme, and 2.835 grams of fresh sage, for a total of 8.221 grams of fresh herbs, for a period of 3 weeks, to create the example wine infusion. The infused bottle of wine was subsequently opened and tested for the presence of free SO2 using the Aeration-Oxidation (AO) Method. A negligible quantity of free SO2 (<5 PPM, well below the 350 PPM permissible in ordinary table wine and the 10 PPM labeling threshold) was noted in the infused wine. A 150 ml sample of the infused wine was then extracted and tested using a RD80 Cash Still to obtain a baseline reading of volatile acidity, noted at 0.4 g/L(±0.05 g/L). The 150 ml sample was then transferred to a 375 ml bottle to immediately increase oxygen exposure and kept unrefrigerated at room temperature.

The infused wine sample was subsequently periodically opened, further exposed to oxygen in the same manner as a consumer would for drinking or cooking over time, and retested for volatile acidity during a test period of 18 days. Notwithstanding the absence of any material quantity of free SO2 that would otherwise act to prevent oxidation and inhibit the development of volatile acidity, volatile acidity in the sample infused wine remained constant and negligible at 0.4 g/L(±0.05 g/L), throughout the testing intervals and at the conclusion of the test period. The above described tests were conducted by a Winery Technician using professional laboratory equipment in a laboratory owned and operated by a licensed, functioning winery.

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method of producing infused wine comprising:
contacting a quantity of wine with a quantity of herbs to form a wine mixture;
placing the wine mixture in a container;
storing the container of the wine mixture at a reduced temperature for a predetermined time;
separating the herbs from the wine mixture to produce infused wine; and
packaging the infused wine.

2. The method of claim 1, further comprising contacting the quantity of wine with a quantity of spices.

3. The method of claim 2, wherein the herbs and spices include anti-bacterial, anti-microbial or anti-oxidative characteristics.

4. The method of claim 2, wherein the spices are one of a group of saffron, sumac, pepper, clove, cinnamon, turmeric, cumin, vanilla, mustard, garlic powder, onion powder and ginger.

5. The method of claim 1, wherein the herbs are one of a group of oregano, rosemary, thyme, sage, bay leaf, parsley, basil, mint, dill, lemongrass, and coriander.

6. The method of claim 1, wherein the storing takes place at a temperature between 45 and 65 degrees F.

7. The method of claim 1, wherein the predetermined time is at least two weeks.

8. The method of claim 1, wherein the quantity of herbs and spices are in a carrying vessel suspended in the container.

9. The method of claim 1 further comprising stirring the wine during the predetermined time.

10. The method of claim 1, wherein the separating is performed by a low-oxygen exposure gravity transfer and feed system.

11. The method of claim 1, further comprising adding a flavoring agent to the wine before the aging step.

12. A system for preserving wine, the system comprising:
a container sealing a mixture of wine and herbs;
an isolation area holding the container with the mixture of wine and herbs for a predetermined amount of time;
a separator to separate the herbs from the wine after the predetermined amount of time; and
an end use container to hold the infused wine.

13. The system of claim 11, wherein the mixture includes spices.

14. The system of claim 12, wherein the herbs and spices include anti-bacterial, anti-microbial or anti-oxidative characteristics.

15. The system of claim 12, wherein the spices are one of a group of saffron, sumac, pepper, clove, cinnamon, turmeric, cumin, vanilla, mustard, garlic powder, onion powder and ginger.

16. The system of claim 11, wherein the herbs are one of a group of oregano, rosemary, thyme, sage, bay leaf, parsley, basil, and coriander.

17. The system of claim 11, wherein the isolation area is maintained at a temperature between 45 and 65 degrees F.

18. The system of claim 11, further comprising a carrying vessel suspended in the container, wherein the herbs and spices are placed in the carrying vessel.

19. The system of claim 11, further a stirring mechanism operable to periodically stir the wine in the container.

20. The system of claim 11, wherein the separator is a low-oxygen exposure gravity transfer and feed system.

21. A beverage comprising:
a wine infused with a plurality of herbs and spices over a predetermined period of time, each of the herbs and spices having anti-bacterial, anti-microbial or anti-oxidative characteristics, wherein the period of time is sufficient to allow preservation of the wine against spoilage for at least 90 days after being exposed to oxygen.

22. The beverage of claim 21, wherein the wine includes at least one flavor imparted from one of the herbs or spices.

23. The beverage of claim 22, wherein the wine includes a flavor imparted from adding a flavoring agent to the wine during the period of time.
